(19) United States
(12) Patent Application Publication
(10) Pub. No.: US 2025/0055739 A1
(43) Pub. Date: Feb. 13, 2025

(54) DEVICE AND METHOD FOR SIGNAL TRANSMISSION IN WIRELESS COMMUNICATION SYSTEM

(71) Applicant: LG ELECTRONICS INC., Seoul (KR)

(72) Inventors: Kyung Ho LEE, Seoul (KR); Sangrim LEE, Seoul (KR); Bonghoe KIM, Seoul (KR); Eunjong LEE, Seoul (KR); Hojae LEE, Seoul (KR)

(21) Appl. No.: 18/722,430

(22) PCT Filed: Dec. 22, 2021
(86) PCT No.: PCT/KR2021/019578

§ 371 Date: Jun. 20, 2024

(51) Int. Cl. H04L 27/26; H04L 5/00

(52) U.S. Cl. CPC H04L 27/261; H04L 5/0023

(57) ABSTRACT

The present disclosure is an embodiment of a method for operating a terminal, and the method for operating a terminal in a wireless communication system includes requesting, by the terminal, reference signal (RS) group-related configuration information to a base station, receiving RS group-related configuration information from the base station, learning a first parameter related to a meta-learning learning model based on the RS group-related configuration information, and receiving, by the terminal, a RS from the base station or transmitting a RS to the base station based on the first parameter. The RS group-related configuration information includes pattern information, an identifier and a weight value of at least one of a demodulation-reference signal (DM-RS), a phase-tracking reference signal (PTRS), a channel status information-reference signal (CSI-RS), a positioning reference signal (PRS), a synchronization signal block (SSB), a sounding reference signal (SRS), and a meta-learning RS.

### CROSS-REFERENCE TO RELATED APPLICATIONS

This application is the National Stage filing under 35 U.S.C. 371 of International Application No. PCT/KR2021/019578, filed on Dec. 22, 2021, which is hereby incorporated by reference herein in their entirety.

### TECHNICAL FIELD

The present disclosure relates to a wireless communication system, and more particularly, to a device and method for signal transmission in a wireless communication system.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

In particular, as a large number of communication devices require a large communication capacity, the enhanced mobile broadband (eMBB) communication technology, as compared to the conventional radio access technology (RAT), is being proposed. In addition, not only massive machine type communications (massive MTC), which provide a variety of services anytime and anywhere by connecting multiple devices and objects, but also a communication system considering a service/user equipment (UE) sensitive to reliability and latency is being proposed. Various technical configurations for this are being proposed.

### SUMMARY

The present disclosure may provide a device and method for signal transmission in a wireless communication system.

The present disclosure may provide a signal transmission method and device for meta learning in a wireless communication system.

The present disclosure may provide a method and device for transmitting a reference signal based on meta learning in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

As an example of the present disclosure, a method for operating a terminal in a wireless communication system includes requesting, by the terminal, reference signal (RS) group-related configuration information to a base station, receiving RS group-related configuration information from the base station, learning a first parameter associated with a meta-learning learning model based on the RS group-related configuration information, and receiving, by the terminal, a RS from the base station or transmitting a RS to the base station based on the first parameter. The RS group-related configuration information includes pattern information, an identifier and a weight value of at least one of a demodulation-reference signal (DM-RS), a phase-tracking reference signal (PTRS), a channel status information-reference signal (CSI-RS), a positioning reference signal (PRS), a synchronization signal block (SSB), a sounding reference signal (SRS), and a meta-learning reference signal. The terminal may learn a second parameter associated with a meta-learning learning model for the RS received from the base station or the RS transmitted to the base station based on the first parameter. For the RS received or transmitted, the terminal may learn the second parameter, starting with a RS with lower density. The density may be determined based on a time, a frequency, and a space of the RS. The terminal may perform a task based on the second parameter. The terminal may select a RS pattern with lowest density from the performed task and give feedback on information on the selected pattern. The terminal may receive RS group configuration information reflecting the feedback and learn the first parameter based on the received RS group configuration information.

As an example of the present disclosure, a terminal in a wireless communication system includes a transceiver and a processor coupled with the transceiver. The processor controls the transceiver to request reference signal (RS) group-related configuration information to a base station. The processor controls the transceiver to receive RS group-related configuration information from the base station. The processor is configured to learn a first parameter associated with a meta-learning learning model based on the RS group-related configuration information. The processor controls the transceiver to receive a RS from the base station or transmit a RS to the base station based on the first parameter. The RS group-related configuration information includes pattern information, an identifier and a weight value of at least one of a demodulation-reference signal (DM-RS), a phase-tracking reference signal (PTRS), a channel status information-reference signal (CSI-RS), a positioning reference signal (PRS), a synchronization signal block (SSB), a sounding reference signal (SRS), and a meta-learning reference signal. The processor may learn a second parameter associated with a meta-learning learning model for the RS received from the base station or the RS transmitted to the base station based on the first parameter. For the RS received or transmitted, the processor may learn the second parameter, starting with a RS with lower density. The density may be determined based on a time, a frequency, and a space of the RS. The processor may perform a task based on the second parameter. The processor may select a RS pattern with lowest density from the performed task. The processor may control the transceiver to give feedback on information on the selected pattern. The processor may control the transceiver to receive RS group-related configuration information reflecting the feedback and may learn the first parameter based on the received RS group-related configuration information.

As an example of the present disclosure, a communication device includes at least one processor and at least one computer memory coupled with the at least one processor and storing an instruction that instructs operations when executed by the at least one processor. The processor may control the communication device to request reference signal (RS) group-related configuration information to a base station, to receive RS group-related configuration information from the base station, to learn a first parameter associated with a meta-learning learning model based on the RS group-related configuration information, and to receive a RS from the base station or transmit a RS to the base station based on the first parameter. The RS group-related configuration information includes pattern information, an identifier and a weight value of at least one of a demodulation-reference signal (DM-RS), a phase-tracking reference signal (PTRS), a channel status information-reference signal (CSI-RS), a positioning reference signal (PRS), a synchronization signal block (SSB), a sounding reference signal (SRS), and a meta-learning reference signal.

As an example of the present disclosure, a non-transitory computer-readable medium storing at least one instruction includes the at least one instruction that is executable by a processor. The at least one instruction may instruct the computer-readable medium to request reference signal (RS) group-related configuration information to a base station, to receive RS group-related configuration information from the base station, and to learn a first parameter associated with a meta-learning learning model based on the RS group-related configuration information, and instruct the terminal to receive a RS from the base station or transmit a RS to the base station based on the first parameter. The RS group-related configuration information includes pattern information, an identifier and a weight value of at least one of a demodulation-reference signal (DM-RS), a phase-tracking reference signal (PTRS), a channel status information-reference signal (CSI-RS), a positioning reference signal (PRS), a synchronization signal block (SSB), a sounding reference signal (SRS), and a meta-learning reference signal.

As an example of the present disclosure, a method for operating a base station in a wireless communication system includes receiving a reference signal (RS) group-related configuration information request message from a terminal, transmitting RS group-related configuration information to the terminal, and receiving a RS from the terminal based on a first parameter associated with a meta-learning learning model or transmitting a RS to the terminal. Based on the RS group-related configuration information, the first parameter associated with the meta-learning learning model is learned. The RS group-related configuration information includes pattern information, an identifier and a weight value of at least one of a demodulation-reference signal (DM-RS), a phase-tracking reference signal (PTRS), a channel status information-reference signal (CSI-RS), a positioning reference signal (PRS), a synchronization signal block (SSB), a sounding reference signal (SRS), and a meta-learning reference signal.

As an example of the present disclosure, a base station in a wireless communication system includes a transceiver and a processor coupled with the transceiver. The processor may control the transceiver to receive a reference signal (RS) group-related configuration information request message from a terminal, control the transceiver to transmit RS group-related configuration information to the terminal, and control the transceiver to receive a RS from the terminal based on a first parameter associated with a meta-learning learning model or to transmit a RS to the terminal. Based on the RS group-related configuration information, the first parameter associated with the meta-learning learning model is learned. The RS group-related configuration information includes pattern information, an identifier and a weight value of at least one of a demodulation-reference signal (DM-RS), a phase-tracking reference signal (PTRS), a channel status information-reference signal (CSI-RS), a positioning reference signal (PRS), a synchronization signal block (SSB), a sounding reference signal (SRS), and a meta-learning reference signal.

The above-described aspects of the present disclosure are merely a part of exemplary embodiments of the present disclosure, and various embodiments reflecting technical features of the present disclosure may be derived and understood by those skilled in the art based on the detailed description of the present disclosure below.

As is apparent from the above description, the embodiments of the present disclosure have the following effects.

According to the present disclosure, a terminal and a base station may transmit and receive a reference signal based on meta learning.

According to the present disclosure, a terminal and a base station may efficiently use a wireless resource for a reference signal.

According to the present disclosure, a terminal and a base station may learn a reference signal that is transmitted and received based on learning data for the reference signal that is transmitted and received and another reference signal.

According to the present disclosure, a terminal and a base station may perform meta learning for a reference signal based on a small amount of datasets.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### BRIEF DESCRIPTION OF THE DRAWINGS

The accompanying drawings are provided to aid understanding of the present disclosure, and embodiments of the present disclosure may be provided together with a detailed description. However, the technical features of the present disclosure are not limited to a specific drawing, and features disclosed in each drawing may be combined with each other to constitute a new embodiment. Reference numerals in each drawing may mean structural elements.

FIG. 1 illustrates an example of a communication system applicable to the present disclosure.

FIG. 2 illustrates an example of a wireless apparatus applicable to the present disclosure.

FIG. 3 illustrates another example of a wireless device applicable to the present disclosure.

FIG. 4 illustrates an example of a hand-held device applicable to the present disclosure.

FIG. 5 illustrates an example of a car or an autonomous driving car applicable to the present disclosure.

FIG. 6 illustrates an example of artificial intelligence (AI) device applicable to the present disclosure.

FIG. 7 illustrates a method of processing a transmitted signal applicable to the present disclosure.

FIG. 8 illustrates a perceptron architecture in an artificial neural network applicable to the present disclosure.

FIG. 9 illustrates an artificial neural network architecture applicable to the present disclosure.

FIG. 10 illustrates a deep neural network applicable to the present disclosure.

FIG. 11 illustrates a convolutional neural network applicable to the present disclosure.

FIG. 12 illustrates a filter operation of a convolutional neural network applicable to the present disclosure.

FIG. 13 illustrates a neural network architecture with a recurrent loop applicable to the present disclosure.

FIG. 14 illustrates an operational structure of a recurrent neural network applicable to the present disclosure.

FIG. 15A to FIG. 15C are views for describing meta learning applicable to the present disclosure.

FIG. 16 illustrates an example of a communication system applicable to the present disclosure.

FIG. 17 illustrates an example of meta training applicable to the present disclosure.

FIG. 18 illustrates an example of a signaling procedure applicable to the present disclosure.

FIG. 19 illustrates an example of adaptation applicable to the present disclosure.

FIG. 20 illustrates an example of signaling applicable to the present disclosure.

FIG. 21A to FIG. 21C illustrate an example of an operation procedure of a terminal applicable to the present disclosure.

FIG. 22 illustrates an example of an operation procedure of a terminal applicable to the present disclosure.

FIG. 23 illustrates an example of an operation procedure of a base station applicable to the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

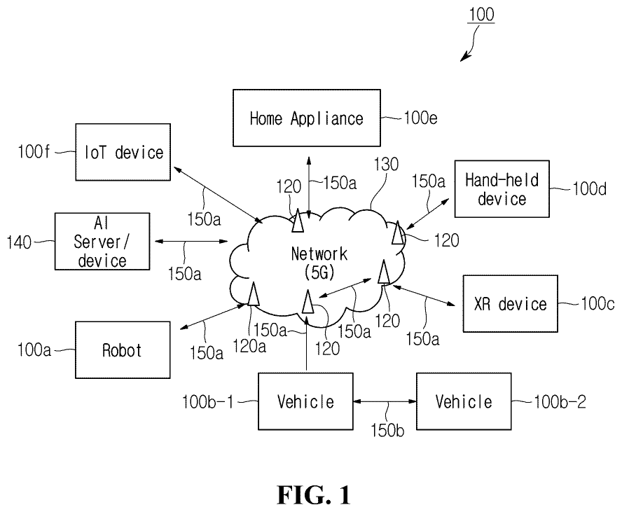

FIG. 1 illustrates an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

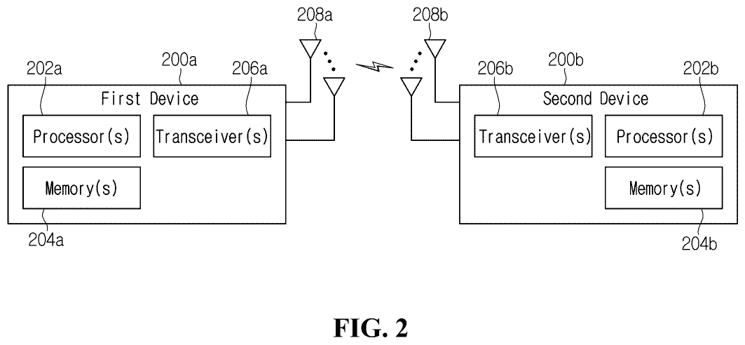

FIG. 2 illustrates an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

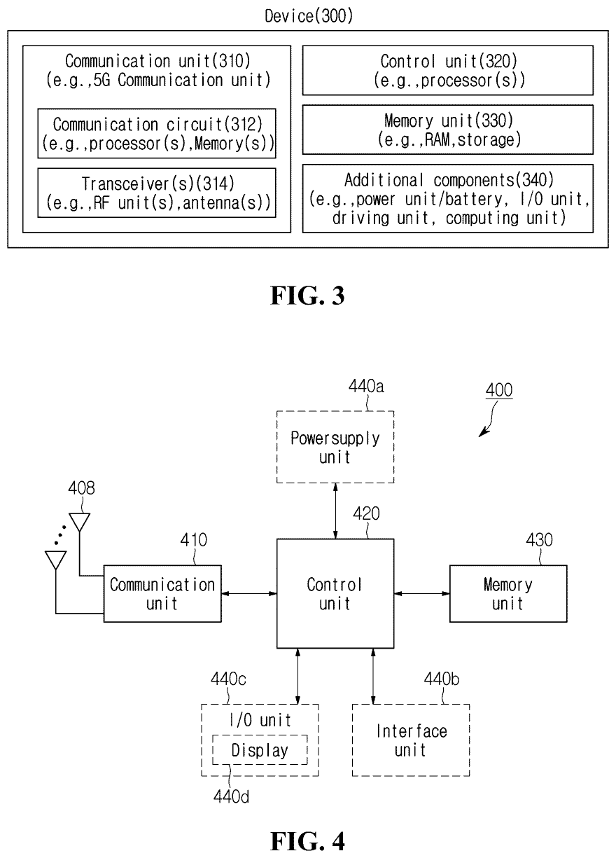

FIG. 3 illustrates another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

FIG. 4 illustrates an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

### Type of Wireless Device Applicable to the Present Disclosure

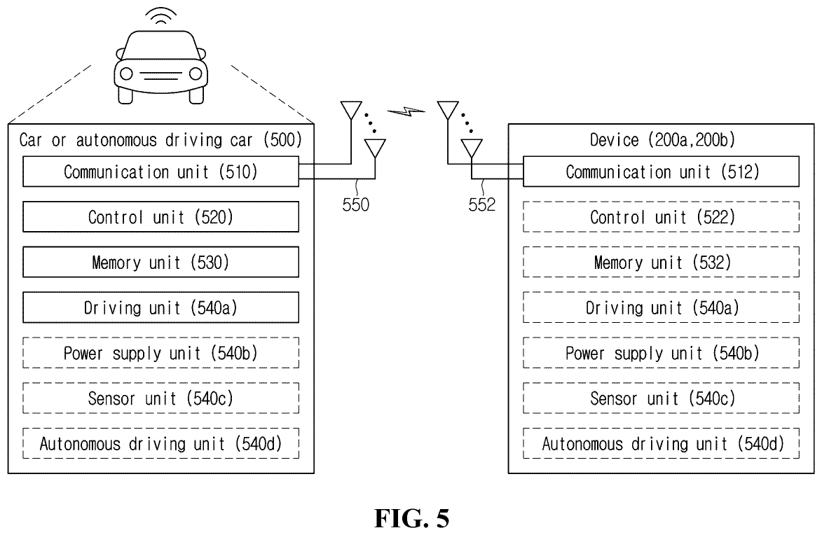

FIG. 5 illustrates an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

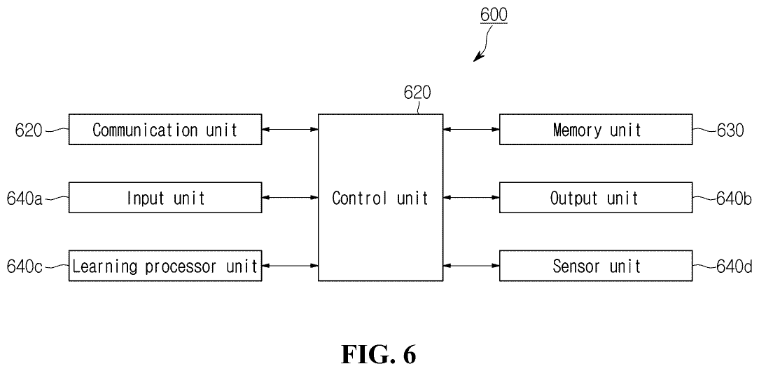

FIG. 6 illustrates an example of artificial intelligence (AI) device applicable to the present disclosure. For example, the AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

Referring to FIG. 6, the AI device 600 may include a communication unit (transceiver) 610, a control unit (controller) 620, a memory unit (memory) 630, an input/output unit 640a/640b, a leaning processor unit (learning processor) 640c and a sensor unit 640d. The blocks 610 to 630/640a to 640d may correspond to the blocks 310 to 330/340 of FIG. 3, respectively.

The communication unit 610 may transmit and receive wired/wireless signals (e.g., sensor information, user input, learning models, control signals, etc.) to and from external devices such as another AI device (e.g., FIG. 1, 100x, 120 or 140) or the AI server (FIG. 1, 140) using wired/wireless communication technology. To this end, the communication unit 610 may transmit information in the memory unit 630 to an external device or transfer a signal received from the external device to the memory unit 630.

The control unit 620 may determine at least one executable operation of the AI device 600 based on information determined or generated using a data analysis algorithm or a machine learning algorithm. In addition, the control unit 620 may control the components of the AI device 600 to perform the determined operation. For example, the control unit 620 may request, search for, receive or utilize the data of the learning processor unit 640c or the memory unit 630, and control the components of the AI device 600 to perform predicted operation or operation, which is determined to be desirable, of at least one executable operation. In addition, the control unit 620 may collect history information including operation of the AI device 600 or user's feedback on the operation and store the history information in the memory unit 630 or the learning processor unit 640c or transmit the history information to the AI server (FIG. 1, 140). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensing unit 640. In addition, the memory unit 630 may store control information and/or software code necessary to operate/execute the control unit 620.

The input unit 640a may acquire various types of data from the outside of the AI device 600. For example, the input unit 640a may acquire learning data for model learning, input data, to which the learning model will be applied, etc. The input unit 640a may include a camera, a microphone and/or a user input unit. The output unit 640b may generate video, audio or tactile output. The output unit 640b may include a display, a speaker and/or a haptic module. The sensing unit 640 may obtain at least one of internal information of the AI device 600, the surrounding environment information of the AI device 600 and user information using various sensors. The sensing unit 640 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The learning processor unit 640c may train a model composed of an artificial neural network using training data. The learning processor unit 640c may perform AI processing along with the learning processor unit of the AI server (FIG. 1, 140). The learning processor unit 640c may process information received from an external device through the communication unit 610 and/or information stored in the memory unit 630. In addition, the output value of the learning processor unit 640c may be transmitted to the external device through the communication unit 610 and/or stored in the memory unit 630.

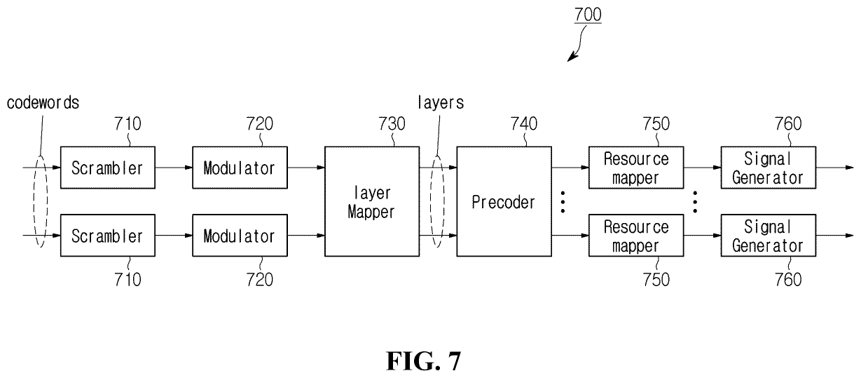

FIG. 7 illustrates a method of processing a transmitted signal applicable to the present disclosure. For example, the transmitted signal may be processed by a signal processing circuit. At this time, a signal processing circuit 700 may include a scrambler 710, a modulator 720, a layer mapper 730, a precoder 740, a resource mapper 750, and a signal generator 760. At this time, for example, the operation/function of FIG. 7 may be performed by the processors 202a and 202b and/or the transceiver 206a and 206b of FIG. 2. In addition, for example, the hardware element of FIG. 7 may be implemented in the processors 202a and 202b of FIG. 2 and/or the transceivers 206a and 206b of FIG. 2. For example, blocks 1010 to 1060 may be implemented in the processors 202a and 202b of FIG. 2. In addition, blocks 710 to 750 may be implemented in the processors 202a and 202b of FIG. 2 and a block 760 may be implemented in the transceivers 206a and 206b of FIG. 2, without being limited to the above-described embodiments.

A codeword may be converted into a radio signal through the signal processing circuit 700 of FIG. 7. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH). Specifically, the codeword may be converted into a bit sequence scrambled by the scrambler 710. The scramble sequence used for scramble is generated based in an initial value and the initial value may include ID information of a wireless device, etc. The scrambled bit sequence may be modulated into a modulated symbol sequence by the modulator 720. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 730. Modulation symbols of each transport layer may be mapped to corresponding antenna port(s) by the precoder 740 (precoding). The output z of the precoder 740 may be obtained by multiplying the output y of the layer mapper 730 by an N*M precoding matrix W. Here, N may be the number of antenna ports and M may be the number of transport layers. Here, the precoder 740 may perform precoding after transform precoding (e.g., discrete Fourier transform (DFT)) for complex modulation symbols. In addition, the precoder 740 may perform precoding without performing transform precoding.

The resource mapper 750 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 760 may generate a radio signal from the mapped modulation symbols, and the generated radio signal may be transmitted to another device through each antenna. To this end, the signal generator 760 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 710 to 760 of FIG. 7. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### Core Implementation Technology of 6G System

### Artificial Intelligence (AI)

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel estimation and channel tracking and may be used for power allocation, interference cancellation, etc. in the physical layer of DL. In addition, machine learning may be used for antenna selection, power control, symbol detection, etc. in the MIMO system.

However, application of a deep neutral network (DNN) for transmission in the physical layer may have the following problems.

Deep learning-based AI algorithms require a lot of training data in order to optimize training parameters. However, due to limitations in acquiring data in a specific channel environment as training data, a lot of training data is used offline. Static training for training data in a specific channel environment may cause a contradiction between the diversity and dynamic characteristics of a radio channel.

In addition, currently, deep learning mainly targets real signals. However, the signals of the physical layer of wireless communication are complex signals. For matching of the characteristics of a wireless communication signal, studies on a neural network for detecting a complex domain signal are further required.

Hereinafter, machine learning will be described in greater detail.

Machine learning refers to a series of operations to train a machine in order to build a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method and a recurrent Boltzmman machine (RNN) method. Such a learning model is applicable.

### Artificial Intelligence System

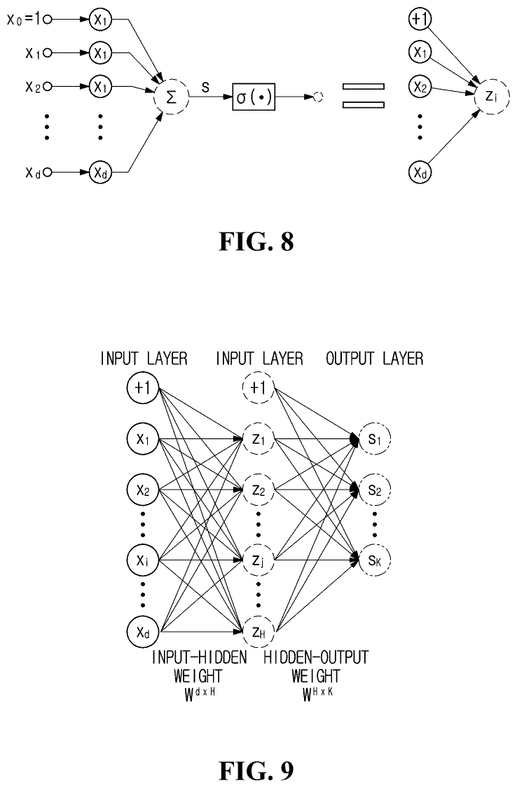

FIG. 8 illustrates a perceptron architecture in an artificial neural network applicable to the present disclosure. In addition, FIG. 9 illustrates an artificial neural network architecture applicable to the present disclosure.

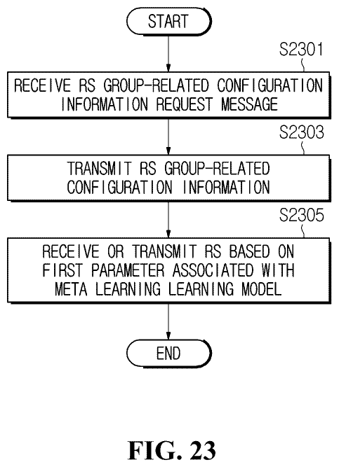

As described above, an artificial intelligence system may be applied to a 6G system. Herein, as an example, the artificial intelligence system may operate based on a learning model corresponding to the human brain, as described above. Herein, a paradigm of machine learning, which uses a neural network architecture with high complexity like artificial neural network, may be referred to as deep learning. In addition, neural network cores, which are used as a learning scheme, are mainly a deep neural network (DNN), a convolutional deep neural network (CNN), and a recurrent neural network (RNN). Herein, as an example referring to FIG. 23, an artificial neural network may consist of a plurality of perceptrons. Herein, when an input vector x={x₁, x₂, . . . , x_{d}} is input, each component is multiplied by a weight {W₁, W₂, . . . , W_{d}}, results are all added up, and then an activation function σ( ) is applied, of which the overall process may be referred to as a perceptron. For a large artificial neural network architecture, when expanding the simplified perceptron structure illustrated in FIG. 23, an input may be applied to different multidimensional perceptrons. For convenience of explanation, an input value or an output value will be referred to as a node.

Meanwhile, the perceptron structure illustrated in FIG. 8 may be described to consist of a total of 3 layers based on an input value and an output value. An artificial neural network, which has H (d+1)-dimensional perceptrons between a 1st layer and a 2nd layer and K (H+1)-dimensional perceptrons between the 2nd layer and a 3rd layer, may be expressed as in FIG. 9.

Herein, a layer, in which an input vector is located, is referred to as an input layer, a layer, in which a final output value is located, is referred to as an output layer, and all the layers between the input layer and the output layer are referred to as hidden layers. As an example, 3 layers are disclosed in FIG. 9, but since an input layer is excluding in counting the number of actual artificial neural network layers, it can be understood that the artificial neural network illustrated in FIG. 8 has a total of 2 layers. An artificial neural network is constructed by connecting perceptrons of a basic block two-dimensionally.

The above-described input layer, hidden layer and output layer are commonly applicable not only to multilayer perceptrons but also to various artificial neural network architectures like CNN and RNN, which will be described below. As there are more hidden layers, an artificial neural network becomes deeper, and a machine learning paradigm using a sufficiently deep artificial neural network as a learning model may be referred to as deep learning. In addition, an artificial neural network used for deep learning may be referred to as a deep neural network (DNN).

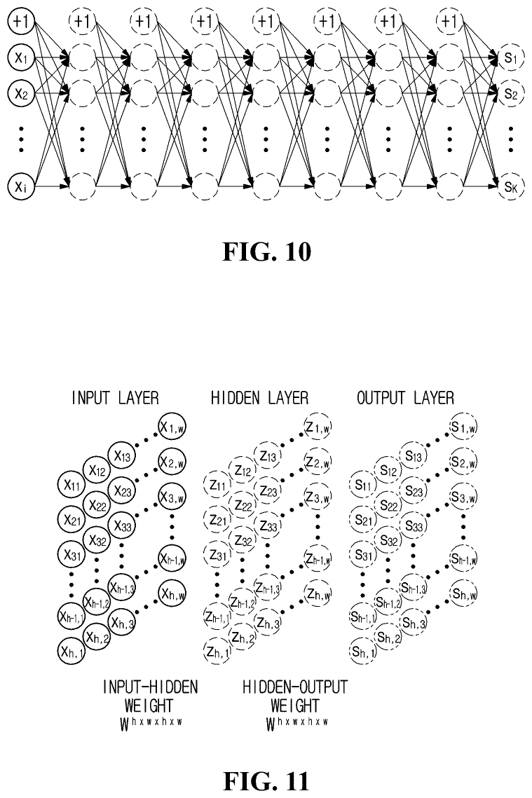

FIG. 10 illustrates a deep neural network applicable to the present disclosure.

Referring to FIG. 10, a deep neural network may be a multilayer perceptron consisting of 8 layers (hidden layers+output layer). Herein, the multilayer perceptron structure may be expressed as a fully-connected neural network. In a fully-connected neural network, there may be no connection between nodes in a same layer and only nodes located in neighboring layers may be connected with each other. A DNN has a fully-connected neural network structure combining a plurality of hidden layers and activation functions so that it may be effectively applied for identifying a correlation characteristic between an input and an output. Herein, the correlation characteristic may mean a joint probability between the input and the output.

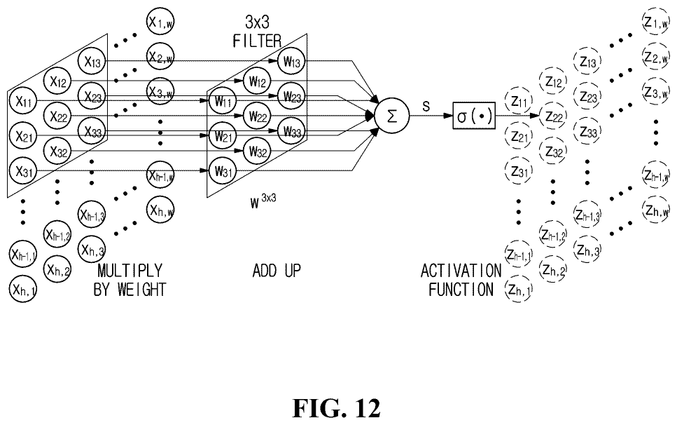

FIG. 11 illustrates a convolutional neural network applicable to the present disclosure. In addition, FIG. 12 illustrates a filter operation of a convolutional neural network applicable to the present disclosure.

As an example, depending on how to connect a plurality of perceptrons, it is possible to form various artificial neural network structures different from the above-described DNN. Herein, in the DNN, nodes located in a single layer are arranged in a one-dimensional vertical direction. However, referring to FIG. 11, it is possible to assume a two-dimensional array of w horizontal nodes and h vertical nodes (the convolutional neural network structures of FIG. 11). In this case, since a weight is applied to each connection in a process of connecting one input node to a hidden layer, a total of h×w weights should be considered. As there are h×w nodes in an input layer, a total of h²w² weights may be needed between two neighboring layers.

Furthermore, as the convolutional neural network of FIG. 11 has the problem of exponential increase in the number of weights according to the number of connections, the presence of a small filter may be assumed instead of considering every mode of connections between neighboring layers. As an example, as shown in FIG. 12, weighted summation and activation function operation may be enabled for a portion overlapped by a filter.

At this time, one filter has a weight corresponding to a number as large as its size, and learning of a weight may be performed to extract and output a specific feature on an image as a factor. In FIG. 12, a 3×3 filter may be applied to a top rightmost 3×3 area of an input layer, and an output value, which is a result of the weighted summation and activation function operation for a corresponding node, may be stored at z₂₂.

Herein, as the above-described filter scans the input layer while moving at a predetermined interval horizontally and vertically, a corresponding output value may be put a position of a current filter. Since a computation method is similar to a convolution computation for an image in the field of computer vision, such a structure of deep neural network may be referred to as a convolutional neural network (CNN), and a hidden layer created as a result of convolution computation may be referred to as a convolutional layer. In addition, a neural network with a plurality of convolutional layers may be referred to as a deep convolutional neural network (DCNN).

In addition, at a node in which a current filter is located in a convolutional layer, a weighted sum is calculated by including only a node in an area covered by the filter and thus the number of weights may be reduced. Accordingly, one filter may be so used as to focus on a feature of a local area. Thus, a CNN may be effectively applied to image data processing for which a physical distance in a two-dimensional area is a crucial criterion of determination. Meanwhile, a CNN may apply a plurality of filters immediately before a convolutional layer and create a plurality of output results through a convolution computation of each filter.

Meanwhile, depending on data properties, there may be data of which a sequence feature is important. A recurrent neural network structure may be a structure obtained by applying a scheme, in which elements in a data sequence are input one by one at each timestep by considering the distance variability and order of such sequence datasets and an output vector (hidden vector) output at a specific timestep is input with a very next element in the sequence, to an artificial neural network.

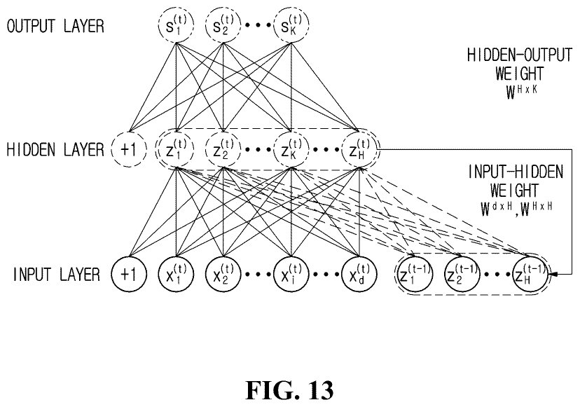

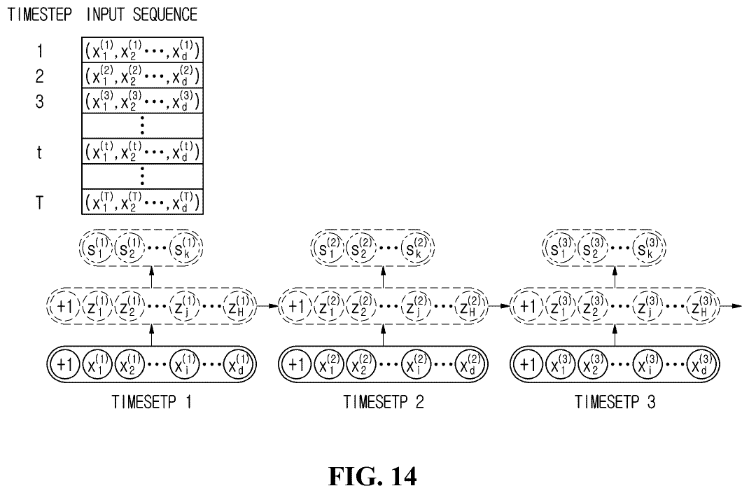

FIG. 13 illustrates a neural network architecture with a recurrent loop applicable to the present disclosure. FIG. 14 illustrates an operational structure of a recurrent neural network applicable to the present disclosure.

Referring to FIG. 13, a recurrent neural network (RNN) may have a structure which applies a weighted sum and an activation function by inputting hidden vectors {z₁^{(t-1)}, z₂^{(t-1)}, . . . , z_{H}^{(t-1)}} of an immediately previous timestep t−1 during a process of inputting elements {x₁⁽¹⁾, x₂⁽¹⁾, . . . , x_{d}⁽¹⁾} of a timestep t in a data sequence into a fully connected neural network. The reason why such hidden vectors are forwarded to a next timestep is because information in input vectors at previous timesteps is considered to have been accumulated in a hidden vector of a current timestep.

In addition, referring to FIG. 14, a recurrent neural network may operate in a predetermined timestep order for an input data sequence. Herein, as a hidden vector {z₁⁽¹⁾, z₂⁽¹⁾, . . . , z_{H}⁽¹⁾} at a time of inputting an input vector {x₁⁽¹⁾, x₂⁽¹⁾, . . . , x_{d}⁽¹⁾} of timestep 1 into a recurrent neural network is input together with an input vector {x₁⁽²⁾, x₂⁽²⁾, . . . , x_{d}⁽²⁾} of timestep 2, a vector {z₁⁽²⁾, z₂⁽²⁾, . . . , z_{H}⁽²⁾} of a hidden layer is determined through a weighted sum and an activation function. Such a process is iteratively performed at timestep 2, timestep 3 and until timestep T.

Meanwhile, when a plurality of hidden layers are allocated in a recurrent neural network, this is referred to as a deep recurrent neural network (DRNN). A recurrent neural network is so designed as to effectively apply to sequence data (e.g., natural language processing).

Apart from DNN, CNN and RNN, other neural network cores used as a learning scheme include various deep learning techniques like restricted Boltzmann machine (RBM), deep belief networks (DBN) and deep Q-Network, and these may be applied to such areas as computer vision, voice recognition, natural language processing, and voice/signal processing.

Recently, there are attempts to integrate AI with a wireless communication system, but these are concentrated in an application layer and a network layer and, especially in the case of deep learning, in a wireless resource management and allocation filed. Nevertheless, such a study gradually evolves to an MAC layer and a physical layer, and there are attempts to combine deep learning and wireless transmission especially in a physical layer. As for a fundamental signal processing and communication mechanism, AI-based physical layer transmission means application of a signal processing and communication mechanism based on an AI driver, instead of a traditional communication framework. For example, it may include deep learning-based channel coding and decoding, deep learning-based signal estimation and detection, deep learning-based MIMO mechanism, and AI-based resource scheduling and allocation.

### Concrete Embodiments of the Present Disclosure

In case a device receives and measures a signal passing a wireless channel based on a pretrained neural network of a wireless communication system, performance may be degraded. It is because there are a very large number of propagation environment features but only a small amount of supervised learning data is obtainable from each feature. That is, a probability of occurrence of a specific propagation environment has a long-tail distribution.

In case a device uses a neural network that is pretrained offline, the device requires a neural network with a very large model and a lot of data for training the neural network. However, it is not easy to collect such data in a communication channel with a long-tail distribution. Even if a terminal moves to experience a new channel, collects data and performs fine-tuning training for an offline-pretrained neural network again, the terminal can hardly reflect a new change sufficiently. It takes much time for a device with insufficient data to adapt to a new channel based on a weight of a large model. Accordingly, in case the device performs communication based on a neural network, the quality of the communication sensitive to speed and latency may be degraded.

Neural network training should reflect effect of a channel between a transmitter and a receiver. A reference signal or a pilot signal may be used as training data to reflect a channel effect. For example, a device may be subject to transmission and reception training for a channel by receiving data based on a demodulation reference signal (DM-RS) for reception. In case the device transmits many DM-RSs to learn a channel effect, the device uses many wireless resources, which is problematic. Accordingly, as consequential problems, there are less resources necessary for data transmission, and spectral efficiency is reduced. Therefore, a neural network requirement technique is needed to enable a device to secure as many reference signal wireless resources as possible and to have fast learning in a propagation environment with a long-tail distribution. Thus, the present disclosure proposes a communication system, a communication procedure, and a signaling method, which are based on online meta learning.

Meta learning uses a neural network that is pretrained based on various tasks. Meta learning is learning that uses such a pretrained neural network to enable a device to well perform inference like regression and classification for a new task. That is, meta learning is a method of enhancing learning and estimation performance for a new task and is learning for learning (learn-to-learn). In the present disclosure, a model weight of a neural network, which is pretrained through a task, is referred to as a meta parameter θ. However, a model weight of a pretrained neural network is not limited to the above-described term. In the present disclosure, learning the meta parameter θ is referred to as meta-training. However, learning a model weight of a pretrained neural network is not limited to the above-described term and may also be referred to as another term. In the present disclosure, when a device experiences a new task, the device relearns a model parameter ϕ suitable for the new task from the meta parameter θ and performs inference based on the relearning, and this is defined as adaptation.

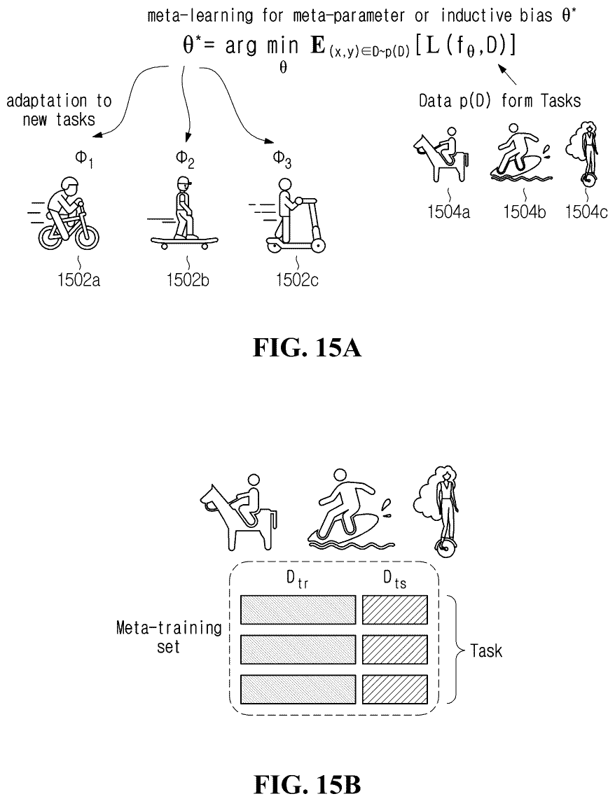

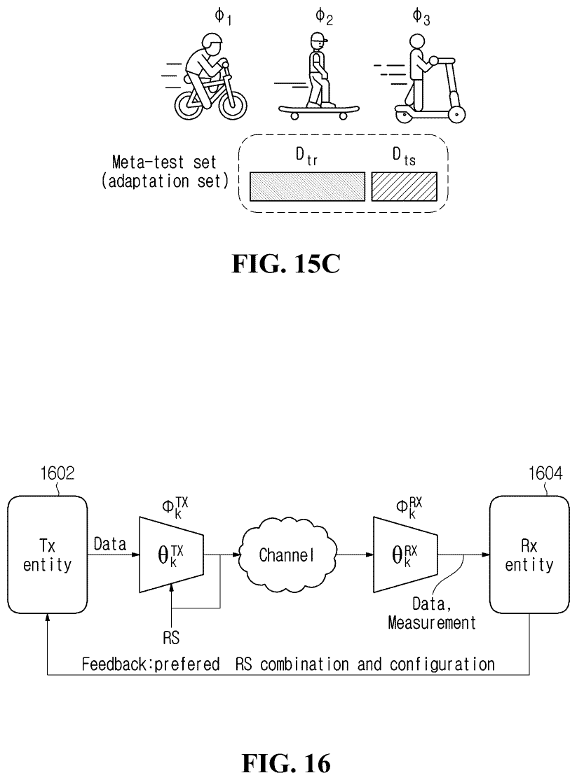

FIG. 15A to FIG. 15C are views for describing meta learning applicable to the present disclosure. FIG. 15A illustrates an example for describing meta learning. Referring to FIG. 15A, a new task is assumed to be riding a bicycle ϕ1 1502a. Herein, in case meta-training is performed beforehand for a task of “riding something”, the new task of riding a bicycle may be easily performed. Before such a new task is given, if a meta parameter is learned by experiencing a task 1 of riding a horse 1504a, a task 2 of riding a surfboard 1504b, and a task 3 of riding an electric unicycle 1504c, adaptation to the new task 1502a of riding a bicycle may be easy. In addition, in this case, adaptation to a new task of riding a skateboard ϕ2 1502b and a new task of riding an electric scooter ϕ3 1502c may become easy.

From the perspective of mathematical modeling, a device collects data from a task distribution p (D) and learns the meta parameter θ based on a neural network model f. Based on the meta parameter, the device may obtain ϕ that is necessary for a new task. The device may perform adaptation based on ϕ. Each task T may be defined as in Formula 1 below.

$$T = \{ L ( θ , D ) , ρ ( {x}_{1} ) , ρ ( {x}_{t + 1} \vert {x}_{t} , {y}_{t} ) , H \} \qquad [ Formula 1 ]$$

In Formula 1, L means a loss function. D means a relevant dataset. ρ(xₜ₊₁|xₜ, yₜ) means a conditional transition probability of task data. H means a time length of this task. In meta learning, a target function of learning the meta parameter θ and a dataset in a task distribution may be expressed as in Formula 2 below.

$${θ}^{*} = arg {min}_{θ} {𝔼}_{( x , y ) ∈ D ∼ p ( D )} [ ℒ ( {f}_{θ} , {D}_{meta \_ train} ) = arg {max}_{θ} p ( θ \vert {D}_{meta \_ train} ) \qquad [ Formula 2 ]$$

In meta-training, a dataset may be configured as a dataset of a plurality of tasks. In addition, one task may have a training set Dir and a test set Dₜₛ.

Referring to FIG. 15B, a task 1 1504a, a task 2 1504b, and a task 3 1504c have datasets respectively. That is, each of the tasks has a training set and a test set. Individual pieces of task data are gathered to become a meta-training set. Referring to FIG. 15C, a device may obtain ϕ for new tasks 1502a, 1502b and 1502c. Adaptation for a new task may be performed by maximizing a conditional probability. As a concrete example, the device may perform adaptation by maximizing a condition probability that best describes an optimal meta parameter [symbol] and meta test data. Meta learning algorithms for obtaining an optimal meta parameter may be classified mainly into three methods: a model (black box)-based method, an optimization-based method, and a non-parametric method. These methods have the following characteristics in common. First, these methods perform generalization for data that is obtained from a distribution of many tasks. Second, these methods sample one task from a meta task data set and repeatedly perform learning by using relevant task data Dₜᵣ and Dₜₛ.

The model-based method is a method of obtaining [symbol] by using another model or a neural network [symbol] that well describes a specific sampled task i. The optimization-based method is a method of obtaining an optimal meta parameter based on gradient information of a current model, not based on a model that best describes a task i. The non-parametric method is a method of considering a model that well describes a feature of [symbol] of a task i.

In case a dataset has a long-tail distribution, meta learning has the greatest effect and performance improvement. In terms of classification, a dataset with a long-tail distribution has a lot of classes, and a data size in each class is very small. Meta learning shows good performance even in a small dataset. As a most useful application example, meta learning may be used for few-shot learning. A device may perform meta learning based on only several images and then show excellent performance in learning of identifying a new image.

The present disclosure proposes a meta learning method for a transmitting/receiving task associated with a reference signal. There are various reference signals. As an example, a device may transmit a phase-tracking reference signal with a specific pattern in order to correct a phase error in a high-frequency band. As another example, the device may transmit a demodulation reference signal (DM-RS) with a specific pattern in order to estimate a channel and to estimate data. As another example, the device may transmit a channel state information-reference signal (CSI-RS) with a specific pattern in order to track time synchronization of a channel, to track a beam, and to find out channel quality information like a rank indicator (RI), a precoding matrix indicator (PMI), and a channel quality indicator (CQI). As another example, the device may transmit a sounding reference signal (SRS) with a specific pattern p for channel sounding. As another example, the terminal may transmit a positioning reference signal (PRS) for measuring a location. The device may transmit various types of reference signals according to purposes and is not limited to the above-described embodiment.

The present disclosure defines transmission/reception and measurement of reference signals as tasks so that a device may use a wireless resource as efficiently as possible. In addition, the present disclosure proposes a method of applying meta learning to transmission/reception and measurement of reference signals.

FIG. 16 illustrates an example of a communication system applicable to the present disclosure. The communication system applicable to the present disclosure incudes a transmission entity (TX entity) 1602 and a reception entity (RX entity) 1604. θ^{TX}ₖ denotes a meta parameter of a TX entity for a specific reference signal (RS) type k at specific time t. θ^{RX}ₖ denotes a meta parameter of a RX entity for a specific RS type k at specific time t. θ^{TX}ₖ denotes an adaptation parameter of a TX entity for a specific RS type k at specific time t. θ^{kX}ₖ denotes an adaptation parameter of a RX entity for a specific RS type k at specific time t.

Hereinafter, a task proposed in the present disclosure will be described. The task may mean transmission/reception and measurement related to all reference signals that have passed a channel at time t. Herein, the reference signals may include a CSI-RS, a PTRS, a PRS, a CRS, and a DMRS. In each task, a result of passing a channel may be used as a dataset. For example, a terminal may perform a task of measuring a CQI based on a CSI-RS. Herein, in case the terminal succeeds in CQI measurement based on the CSI-RS, a result may be used as one supervised learning dataset. A dataset related to a task may be divided into a training set Dₜᵣ and a test set Dₜₛ in an appropriate proportion.

Meanwhile, online meta learning proposed in the present disclosure may be divided mainly into two parts as follows. Meta-training is a procedure in which a device learns an optimal meta parameter [symbol] based on a meta-training data set of every reference signal. Adaptation is a procedure in which the device learns ϕ by learning based on the optimal meta parameter [symbol] to succeed in a task for a specific reference signal and performs a task related to the reference signal at the same time.

In case the device succeeds in adaptation of the reference signal task, the device may obtain a reference signal dataset and a parameter ϕ for the task. When the device acquires [symbol] , meta training may be performed by inputting the reference signal dataset and the task parameter obtained from the adaptation. In addition, the device may acquire ϕ by performing a specific task based on [symbol] obtained from the meta training, thereby performing adaptation.

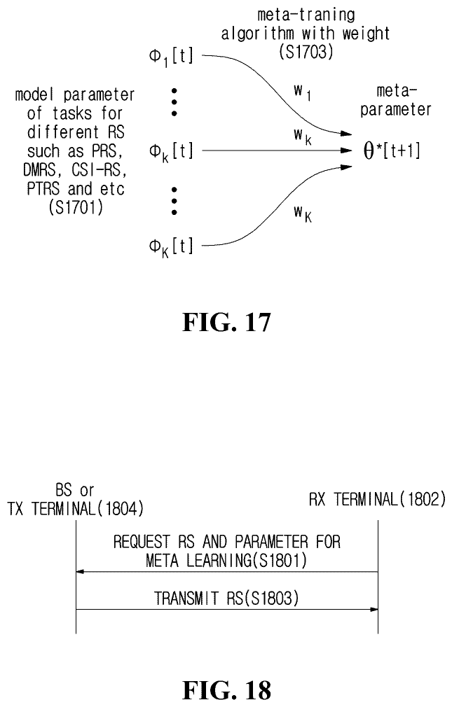

FIG. 17 illustrates an example of meta training applicable to the present disclosure. Hereinafter, meta training will be described in detail. A device may use datasets obtained from a current reference signal (RS) task and tasks that are obtained from all the other types of RSs. For example, the device may use datasets obtained from tasks obtained from RSs such as a PRS, a DMRS, a CSI-RS and a PTRS. The device may acquire model parameters from different tasks (S1701). To calculate a meta parameter, the device may perform meta training by applying a weight to the model parameters obtained from the different tasks (S1703). Meta-training algorithms may be classified into a metric-based algorithm, an optimization-based algorithm, and a model-based algorithm. The above-described algorithms may all be applied as a meta-training algorithm.

FIG. 18 illustrates an example of a signaling procedure applicable to the present disclosure. Referring to FIG. 18, at step S1801, for meta training, a user equipment (UE) may request information related to a preferred RS set and a parameter for meta learning to a base station (BS) 1804 or a transmission user equipment (TX UE) 1804.

A preferred RS set is a set consisting of every possible combination of RSs for meta learning. For example, the preferred RS set may include at least one of a DMRS, a PTRS, a CSI-RS, a PRS, a synchronization signal block (SSB), an SRS, a cell-specific reference signal (CRS), and a meta learning RS. As a more concrete example, the preferred RS set may include at least one of a DMRS including data, a DMRS without data, a PTRS including data, a PTRS without data, a CSI-RS for beam measurement, a CSI-RS for link quality measurement, a CSI-RS for time-frequency synchronization measurement, a PRS for location measurement, an SSB for synchronization, an SRS transmitted by a terminal, a CRS, and a meta learning RS transmitted at a specific port for meta learning.

A parameter for meta learning may include an identifier and a meta-training weight value for each RS. At step S1803, the BS or the TX UE may transmit a combination of RSs in response to the RS set request of the RX UE. Specifically, the BS or the UE may determine a set of RSs based on a received parameter. As an example, the BS or the UE may increase power of a RS and the density and diversity of a RS pattern along with increase of weight. The BS or the UE may determine a set of RSs in various ways based on a meta-training weight value and is not limited to the above-described embodiment.

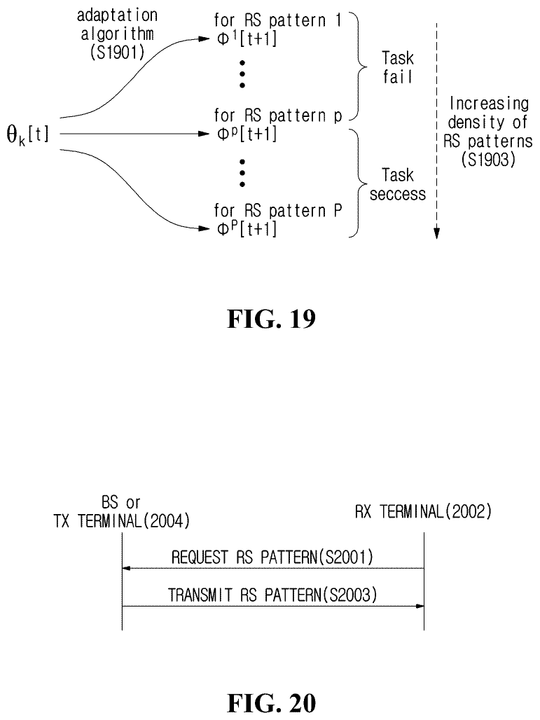

FIG. 19 illustrates an example of adaptation applicable to the present disclosure. Unlike meta training, adaptation is a task that a UE should perform for a specific RS. For example, a UE may perform a task for achieving a purpose of each RS of 4G LTE and 5G NR.

At step S1901, a device may attempt an adaptation algorithm based on a meta parameter. For example, the device may attempt the adaptation algorithm for a subset of a current RS pattern based on the meta parameter. Referring FIG. 19, based on the meta parameter, the device may attempt a task for a RS pattern 1, a RS pattern 2, . . . a RS pattern p, . . . , and a RS pattern P.

At step S1903, the device may attempt a task while increasing density of a RS pattern. The device may perform adaptation based on a RS pattern with lowest density among RS patterns for which a task attempt is successful. Accordingly, the device may save a wireless resource. For example, in case a CSI-RS is used for channel quality information (CQI) measurement, the device may measure CQI for every possible low-density sub-pattern from a current RS pattern and select a pattern with lowest density. Density may be determined based on time, frequency and space of a RS.

FIG. 20 illustrates an example of signaling applicable to the present disclosure. At step S2001, a RX UE may request a preferred RS pattern to a BS or a TX UE. At step S2003, the BS or the TX UE may transmit the preferred RS pattern to the BS or the RX. When selecting a RS set of meta training or a RS pattern of adaptation, a UE may perform optimization at the same time. The RX UE may perform adaptation and meta training, which are proposed in the present disclosure, for a RS set that is currently being set. In order to perform meta training quickly, the RX UE may give feedback on a RS combination for which adaptation is successful. As an example, the UE may give feedback on a low-density pattern of a preferred RS for which adaptation is successful. The TX UE or the BS may transmit a RS set with a low-density RS pattern based on feedback information. In case the RX UE fails adaptation for every pattern, a pattern with highest density may be preferred. For example, in case the UE fails adaptation for every RS pattern, the UE may select a RS pattern with highest density and give feedback to the TX UE or the BS.

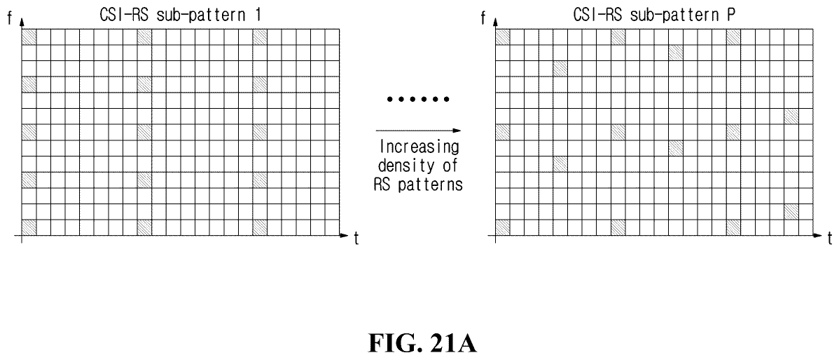

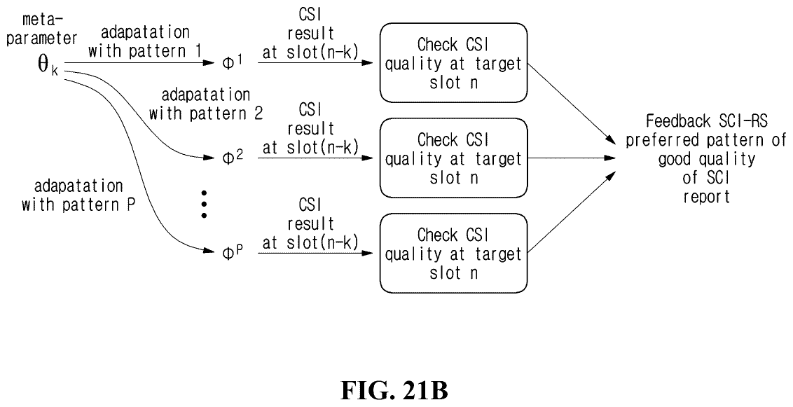

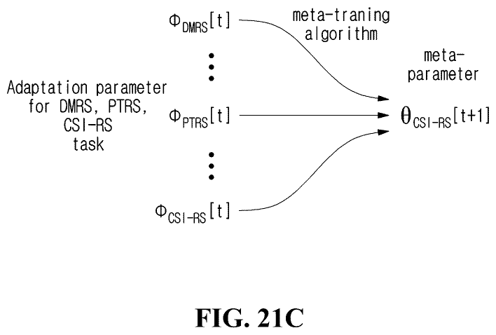

FIG. 21A to FIG. 21C illustrate an example of an operation procedure of a terminal applicable to the present disclosure. Referring to FIG. 21A to FIG. 21B, the terminal may perform adaptation in ascending order of density of a sub-pattern of a CSI-RS. The terminal may measure and report CSI information for a target slot n at a slot n-k. In addition, the terminal may perform adaptation for each sub-pattern. At a target slot n, the terminal may check whether or not adaptation is successful for each pattern and give feedback on information on a low-density sub-pattern to a TX side. Referring to FIG. 21C, the terminal may perform meta training even in case not only the CSI-RS but also currently transmitted/received DMRS and PTRS are configured together.

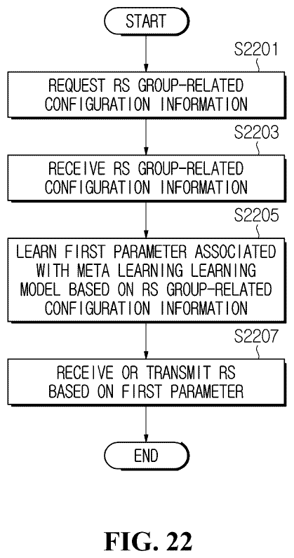

FIG. 22 illustrates an example of an operation procedure of a terminal applicable to the present disclosure.

At step S2201, the terminal requests RS group-related configuration information to another terminal or a base station. At step S2203, the terminal receives the RS group-related configuration information from another terminal or the base station. The RS group-related configuration information includes pattern information, an identifier and a weight value of at least one of a demodulation-reference signal (DM-RS), a phase-tracking reference signal (PTRS), a channel status information-reference signal (CSI-RS), a positioning reference signal (PRS), a synchronization signal block (SSB), a sounding reference signal (SRS), and a meta-learning reference signal. As a more concrete example, the RS group-related configuration information may include at least one of a DMRS including data, a DMRS without data, a PTRS including data, a PTRS without data, a CSI-RS for beam measurement, a CSI-RS for link quality measurement, a CSI-RS for time-frequency synchronization measurement, a PRS for location measurement, an SSB for synchronization, an SRS transmitted by a terminal, a CRS, and a meta learning RS transmitted at a specific port for meta learning.

At step S2205, the terminal learns a first parameter related to a meta learning learning model based on the RS group-related configuration information. As described in FIG. 15 to FIG. 21, the device may learn a meta parameter related to a meta learning learning model.

At step S2207, the terminal may receive or transmit a RS based on the first parameter. In addition, the terminal may learn a second parameter related to a meta learning learning model for a RS received from the base station or a RS transmitted to the base station. That is, as described above, the terminal may perform adaptation in relation to a received/transmitted RS. A RS, which the terminal receives/transmits, may be different from a RS that is used to learn the first parameter.

As described, the terminal may attempt tasking from a RS pattern with low density. For the received or transmitted RS, the terminal may learn the second parameter, starting with a RS with lower density. In addition, the terminal may perform a task based on the second parameter. The density may be determined based on the time, frequency and space of a RS. The terminal may select a RS pattern with lowest density from the performed task and give feedback on the selected pattern information to a base station or another terminal. The terminal may receive RS group configuration information reflecting the feedback and learn the first parameter based on the received RS group configuration information. That is, the terminal may perform adaptation for a transmitted/received RS and give feedback on a result, and meta training may be performed based on such feedback.

FIG. 23 illustrates an example of an operation procedure of a base station applicable to the present disclosure.

At step S2301, the base station receives a RS group-related configuration information request message. At step S2303, the base station transmits RS group-related configuration information to a terminal. Based on the RS group-related configuration information, a first parameter related to a meta learning learning model is learned.

At step S2305, the base station receives or transmits a RS based on the first parameter related to the meta learning learning model. The RS group-related configuration information includes pattern information, an identifier and a weight value of at least one of a demodulation-reference signal (DM-RS), a phase-tracking reference signal (PTRS), a channel status information-reference signal (CSI-RS), a positioning reference signal (PRS), a synchronization signal block (SSB), a sounding reference signal (SRS), and a meta-learning reference signal.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

### INDUSTRIAL APPLICABILITY

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method performed by a terminal in a wireless communication system, the method comprising:
generating at least one transport block;
encoding the at least one transport block to generate a codeword;
converting the codeword into a bit sequence that is scrambled;
modulating the bit sequence to generate modulated symbols;
generating a signal by performing at least one of an inverse fast Fourier transform (IFFT), a cyclic prefix (CP) insertion, a digital-to-analog conversion, and a frequency uplink converter;
transmitting the signal to a base station, the signal including a request for configuration information related to a reference signal (RS);
receiving configuration information related to the RS from the base station;
learning a first parameter related to a meta-learning learning model based on the configuration information related to the RS; and
receiving a RS from the base station or transmitting a RS to the base station based on the first parameter,
wherein the configuration information related to the RS includes pattern information, an identifier and a weight value of at least one of a demodulation-reference signal (DM-RS), a phase-tracking reference signal (PTRS), a channel status information-reference signal (CSI-RS), a positioning reference signal (PRS), a synchronization signal block (SSB), a sounding reference signal (SRS), and a meta-learning RS.

2. The method of claim 1, further comprising:
learning a second parameter related to a meta-learning learning model for the RS received from the base station or the RS transmitted to the base station based on the first parameter.

3. The method of claim 2, further comprising:
for the RS received or transmitted, learnings the second parameter, by prioritizing a RS with lower density, and
wherein the density is determined based on a time, a frequency, and a space of the RS.

4. The method of claim 3, further comprising:
performing a task based on the second parameter.

5. The method of claim 4, further comprising:
selecting a RS pattern with lowest density from the performed task, and
transmitting a feedback on information on the selected pattern.

6. The method of claim 5, receiving configuration information related to the RS reflecting the feedback, and
learning the first parameter based on the received configuration information related to the RS.

7. A terminal in a wireless communication system, the terminal comprising:
a transceiver; and
a processor coupled with the transceiver and configured to:
transmit a request for reference signal (RS) group-related configuration information to a base station,
receive configuration information related to the RS from the base station,
learn a first parameter related to a meta-learning learning model based on the configuration information related to the RS, and
receive a RS from the base station or transmit a RS to the base station based on the first parameter, and
wherein the configuration information related to the RS includes pattern information, an identifier and a weight value of at least one of a demodulation-reference signal (DM-RS), a phase-tracking reference signal (PTRS), a channel status information-reference signal (CSI-RS), a positioning reference signal (PRS), a synchronization signal block (SSB), a sounding reference signal (SRS), and a meta-learning RS.

8. The terminal of claim 7, wherein the processor is further configured to learns a second parameter related to a meta-learning learning model for the RS received from the base station or the RS transmitted to the base station based on the first parameter.

9. The terminal of claim 8, wherein for the RS received or transmitted, the processor is further configured to learns the second parameter, starting with a RS with lower density, and
wherein the density is determined based on a time, a frequency, and a space of the RS.

10. The terminal of claim 9, wherein the processor is further configured to performs a task based on the second parameter.

11. The terminal of claim 10, wherein the processor is further configured to:
selects a RS pattern with lowest density from the performed task, and
transmit feedback on information on the selected pattern.

12. The terminal of claim 11, wherein the processor is further configured to:
receive configuration information related to the RS reflecting the feedback, and
learn the first parameter based on the received configuration information related to the RS.

13.-14. (canceled)

15. A method performed by a base station in a wireless communication system, the method comprising:
receiving a request for reference signal (RS) group-related configuration information from a terminal;
transmitting the configuration information related to the RS to the terminal; and
receiving a RS from the terminal based on a first parameter related to a meta-learning learning model or transmitting a RS to the terminal,
wherein, based on the configuration information related to the RS, the first parameter related to the meta-learning learning model is learned, and
wherein the configuration information related to the RS includes pattern information, an identifier and a weight value of at least one of a demodulation-reference signal (DM-RS), a phase-tracking reference signal (PTRS), a channel status information-reference signal (CSI-RS), a positioning reference signal (PRS), a synchronization signal block (SSB), a sounding reference signal (SRS), and a meta-learning RS.

16. (canceled)
